(19) United States
(12) Patent Application Publication
(10) Pub. No.: US 2026/0073318 A1
(43) Pub. Date: Mar. 12, 2026

(54) System And Method For Workload Aware Dynamic Scheduling Of Multi-Unit And Multi-Skill Workforce

(71) Applicant: Quantiphi, Inc., Marlborough, MA (US)

(72) Inventors: Dagnachew Birru, Marlborough, MA (US); Anirudh Deodhar, Mumbai (IN); Vipul Patel, Mumbai (IN); Tanmaya Singhal, Mumbai (IN)

(21) Appl. No.: 19/388,399

(22) Filed: Nov. 13, 2025

(51) Int. Cl. G06Q 10/0631; G06N 20/00

(52) U.S. Cl. CPC G06Q 10/063112; G06Q 10/063119; G06N 20/00

(57) ABSTRACT

A method (500) and system (100) for optimizing workforce allocation across units is disclosed. The method (500) includes receiving data associated with the units. The method (500) may include identifying employee pool, skill demand and workload index of each of units. The method (500) may further include generating schedule for each unit based on skill demand, workload index, and scheduling constraints. The method (500) may include identifying surplus units and deficit units, and deficit skills based on generated schedule. Further, the method (500) included determining that employee relocation is required based on surplus units, deficit units and deficit skills. The method (500) further includes identifying employees that are eligible for relocation from surplus units based on deficient skills and employee preferences. The method (500) further includes validating employee relocation options based on identified eligible employees. Further, the method (500) includes executing optimal employee relocation option from validated employee relocation options.

### FIELD OF THE INVENTION

The present disclosure relates to workforce allocation, and more specifically to a system and method for optimizing employee allocation across multiple units.

### BACKGROUND OF THE INVENTION

Workforce scheduling in complex organizational environments, such as healthcare systems, manufacturing facilities, and service networks, has been a long-standing operational challenge. The workforce scheduling involves aligning employee availability, skill sets, and regulatory requirements with fluctuating demand for services. Conventional scheduling approaches typically focus on fulfilling headcount requirements for each shift, neglecting finer-grained aspects such as employee certifications, workload intensity, and inter-unit workforce mobility.

In a healthcare settings, for example, hospitals and clinics operate across multiple units, each requiring a distinct mix of specialized staff. Conventional scheduling methods assume homogeneity in employee capabilities and workload distribution, overlooking the reality that employees may possess varied certifications or may face shifts with vastly different levels of workload intensity. Such oversights can lead to inequitable assignments, employee dissatisfaction, and increased risk of burnout.

Furthermore, the challenge becomes more acute when considering networks of multiple units operating under a common management structure. Demand surge in one unit may coincide with underutilization of resources in another units. In many cases, relocation of employees between units is performed manually, based on ad hoc decisions, and without systematic optimization, creating inefficiencies in overall resource utilization and risks compromising service quality and employee well-being.

Research in workforce scheduling has explored various computational methods including mixed-integer programming, heuristic optimization, and constraint programming to improve scheduling accuracy and efficiency. Some solutions incorporate predictive techniques to estimate future demand and workforce requirements. However, the conventional approaches are generally limited to single-unit optimization and often fail to account for the dynamic redistribution of workforce resources across multiple units in response to real-time changes in demand. Furthermore, conventional scheduling systems lack orchestration mechanisms to integrate forecasting tools, optimization solvers, and workforce relocation decisions into a cohesive workflow. The absence of such coordinated frameworks results in fragmented decision-making, suboptimal schedules, and difficulty in adapting to sudden workload fluctuations.

Therefore, there exists a need for improved scheduling systems that consider diverse workforce skills, workload variability, and inter-unit workload, while enabling flexible and scalable management of multi-unit, multi-skill environments.

### SUMMARY

The following embodiments presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide computer-implemented method for optimizing workforce allocation across a plurality of units, the method may include receiving a plurality of data associated with the plurality of units. The plurality of data includes one or more of a demand of the plurality of units, employee details, employee preference, patient data, employee skills, and scheduling constraints. The method may further include identifying an employee pool, a skill demand and a workload index of each of the plurality of units using a skill-workload forecaster tool. The method may further include generating a schedule for each of the plurality of units based on the skill demand, the workload index, and the scheduling constraints using a scheduling solver tool. The method may further include identifying one or more surplus units and deficit units from each of the plurality of units, and one or more deficit skills based on the generated schedule using a schedule evaluation tool. Further, the method may include determining that an employee relocation is required based on the one or more surplus units, deficit units and deficit skills. Further, the method include identifying the employees that are eligible for the relocation from the surplus units based on the one or more deficient skills and employee preferences. The method may include validating a plurality of employee relocation options based on the identified eligible employees using a relocation option identifier tool. Further, the method may include executing an optimal employee relocation option from the plurality of validated employee relocation options using a relocation optimizer tool.

According to some example embodiments, the skill-workload forecaster tool comprises at least one of a Machine Learning (ML) model and a rule based engine to generate the skill demand and workload index.

According to some example embodiments, the scheduling solver tool comprises one or more optimization techniques selected from a group consisting of a genetic algorithm, a linear programming algorithm, a constraint programming algorithm, and a reinforcement learning model.

According to some example embodiments, the method includes computing a schedule fitness score indicative of the surplus units, the deficit units, and the skill deficit across the plurality of units.

According to some example embodiments, the method includes determining that the employee relocation is not required based on the one or more surplus units, deficit units and deficit skills. Further, the method includes continuously receiving the plurality of data associated with the plurality of units.

According to some example embodiments, the relocation optimizer tool reuses the scheduling solver tool to evaluate each of the plurality of validated employee relocation options and select the optimal employee relocation option.

According to some example embodiments, the method further includes implementing the optimal employee relocation option using at least one of an Electronic Health Record (EHR) and an Enterprise Resource Planning (ERP).

Some example embodiments disclosed herein provide a computer-implemented system for optimizing employee allocation across a plurality of units. The computer-implemented system includes a master agent configured to receive a plurality of data associated with the plurality of units. The plurality of data includes one or more of a demand of the plurality of units, employee details, employee preference, patient data, employee skills, and scheduling constraints. Further, the master agent is configured to identify an employee pool, a skill demand and a workload index of each of the plurality of units using a skill-workload forecaster tool. The system further includes a scheduling decision agent configured to generate a schedule for each of the plurality of units based on the skill demand, the workload index, and the scheduling constraints using a scheduling solver tool. The scheduling decision agent is configured to identify one or more surplus units and deficit units from each of the plurality of units, and one or more deficit skills based on the generated schedule using a schedule evaluation tool. Further, the system may include a relocation decision agent configured to determine that an employee relocation is required based on the one or more surplus units, deficit units and deficit skills. Further, the relocation decision agent is configured to identify the employees that are eligible for the relocation from the surplus units based on the one or more deficient skills and employee preferences. The relocation decision agent is configured to validate a plurality of employee relocation options based on the identified eligible employees using a relocation option identifier tool. The relocation decision agent is further configured to execute an optimal employee relocation option from the plurality of validated employee relocation options using a relocation optimizer tool.

Some example embodiments disclosed herein provide a non-transitory computer readable medium having stored thereon computer executable instruction which when executed by one or more processors, cause the one or more processors to carry out operations for optimizing employee allocation across a plurality of units, the operations includes receiving a plurality of data associated with the plurality of units. The plurality of data includes one or more of a demand of the plurality of units, employee details, employee preference, patient data, employee skills, and scheduling constraints. Further, the operations includes identifying an employee pool, a skill demand and a workload index of each of the plurality of units using a skill-workload forecaster tool. The operations include generating a schedule for each of the plurality of units based on the skill demand, the workload index, and the scheduling constraints using a scheduling solver tool. Further, the operations include identifying one or more surplus units and deficit units from each of the plurality of units, and one or more deficit skills based on the generated schedule using a schedule evaluation tool. The operation may include determining that an employee relocation is required based on the one or more surplus units, deficit units and deficit skills. Further, the operations may include identifying the employees that are eligible for the relocation from the surplus units based on the one or more deficient skills and employee preferences. The operations may further include validating a plurality of employee relocation options based on the identified eligible employees using a relocation option identifier tool. Further, the operations may include executing an optimal employee relocation option from the plurality of validated employee relocation options using a relocation optimizer tool.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system for optimizing employee allocation across multiple units, in accordance with an example embodiment;

FIG. 2 illustrates a block diagram of a system architecture for optimizing employee allocation across multiple units, in accordance with an example embodiment;

FIG. 3 illustrates a block diagram of a system architecture of a scheduling solver tool, in accordance with an example embodiment;

FIG. 4 illustrates a block diagram of a system architecture of a relocation option identifier tool, in accordance with an example embodiment;

FIG. 5 illustrates a flow diagram of a method for optimizing employee allocation across multiple units, in accordance with an example embodiment;

FIG. 6 illustrates a flow diagram of a method for relocation optimization of employee allocation across multiple units, in accordance with an example embodiment;

FIG. 7 illustrates a flow diagram of a method for optimizing employee allocation across multiple units, in accordance with an example embodiment; and

FIG. 8 illustrates a block diagram of an exemplary computer system for implementing embodiments consistent with the present disclosure.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method. Further, the term “relocation” is intended to cover the virtual or physical transfer of employees with a unit or within multiple units such as within departments of a hospital or within multiple hospitals at different geographical locations.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Employee scheduling” may refer to a process of allocating employees to specific shifts or tasks within one or more units, considering skills, workload requirements, preferences, and operational constraints.

The term “Skill demand” may refer to a specific type and quantity of employee skills required to perform tasks during a given shift or period.

The term “Workload” may be used to refer to a measure of effort or intensity of tasks associated with a particular shift, influenced by patient acuity, task complexity, or service volume.

The term “Scheduling constraints” may refer to a set of rules, regulations, or requirements such as labour laws, shift length, break periods, staff preferences, and certification requirements that govern workforce scheduling.

The term “Workload index” may refer to a quantitative metric representing the relative intensity of a shift, typically expressed on a normalized scale (e.g., 0-1), to balance staff assignments and prevent burnout.

The term “Surplus unit” may refer to a unit or department that has more employees or skills available than required for its forecasted workload.

The term “Deficit unit” may refer to a unit or department that has fewer employees or skills available than required for its forecasted workload.

The term “Deficit skills” may refer to specific employee skills that are insufficient within a given unit to meet the predicted demand.

The term “Employee relocation” may refer to a temporary or permanent reassignment of employees from one unit to another to balance workforce availability and skill distribution.

The term “Schedule fitness score” may refer to a calculated value indicative of how well a generated schedule meets objectives such as minimizing deficits, balancing workloads, and aligning with constraints.

The term “Electronic Health Record (EHR)” may refer to a digital system that stores and manages patient-related medical information, enabling integration of patient care requirements with workforce scheduling.

The term “Enterprise Resource Planning (ERP)” may refer to a software system used for managing organizational operations, including workforce planning, financials, and resource allocation, which can integrate with the scheduling framework.

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

### End of Definitions

As described earlier, the present disclosure relates generally to workforce management systems, and more particularly, to workload-aware and skill-based scheduling of employees across multiple organizational units. Conventional scheduling techniques primarily assign employees based on headcount requirements without adequately considering employee certifications, skill diversity, or the variability of workload intensity across shifts. Further, workforce pools are often managed as isolated units, which creates inefficiencies when sudden demand surges occur in specific units while others remain underutilized. Manual relocation of employees between units is typically ad hoc, time-consuming, and does not account for employee preferences, skill compatibility, or operational continuity. The shortcomings may lead to employee burnout, suboptimal resource utilization, increased overtime costs, and compromised quality of service delivery.

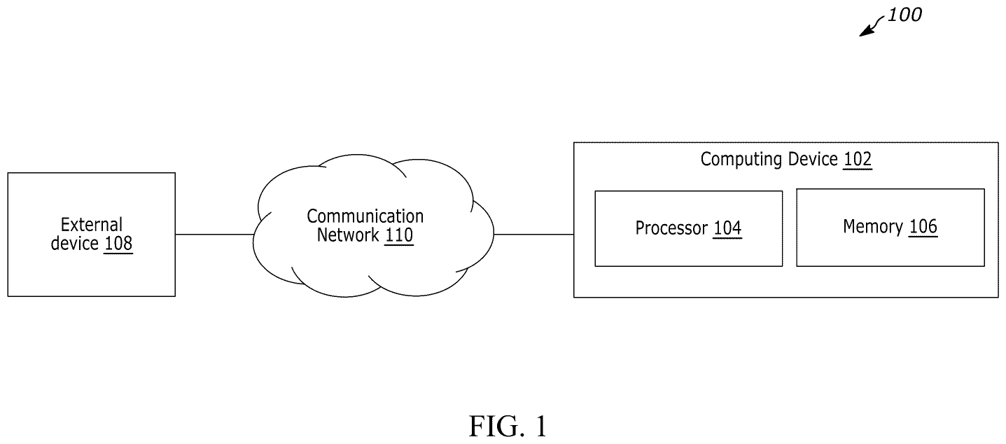

The present disclosure provides a system and method for workload-aware dynamic scheduling of a multi-unit, multi-skilled workforce. The system integrates a skill-workload forecaster, a scheduling solver, and a relocation optimization framework orchestrated through intelligent agents. The skill-workload forecaster predicts demand for specific skills and workload intensity for upcoming shifts. The scheduling solver generates optimized schedules for each unit by incorporating people constraints, shift rules, workload indices, and employee preferences. A relocation decision agent evaluates surplus and deficit units, identifies skill shortages, and validates optimal relocation options to reallocate employees across units dynamically. The architecture employs a two-stage optimization process first identifying feasible inter-unit relocation options and then refining schedules at the unit level. The system may be implemented with multiple optimization techniques such as genetic algorithms, linear programming, or reinforcement learning. The disclosed framework ensures balanced workloads, improved employee satisfaction, reduced overtime, and enhanced operational efficiency, while supporting seamless integration with enterprise systems such as the EHR and the ERP. Embodiments of the present disclosure may provide a method, a system, and a computer program product for explainable optimization of protein sequence using inverse folding model. The method, the system, and the computer program product optimize the employee allocation across multiple units in such an improved manner are described with reference to FIG. 1 to FIG. 8 as detailed below.

FIG. 1 illustrates a block diagram of an environment of a system 100 for optimizing employee allocation across multiple units, in accordance with an example embodiment. The system 100 is designed to facilitate optimization of employee allocation across multiple units. The system 100 includes a computing device 102 and an external device 108. The computing device 102 may be communicatively coupled with the external device 108 via a communication network 110. Examples of the computing device 102 may include, but are not limited to, a server, a desktop, a laptop, a notebook, a tablet, a smartphone, a mobile phone, an application server, or the like.

The communication network 110 may be wired, wireless, or any combination of wired and wireless communication networks, such as cellular, Wi-Fi, internet, local area networks, or the like. In one embodiment, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may include a memory 106, and a processor 104. The term “memory” used herein may refer to any computer-readable storage medium, for example, volatile memory, random access memory (RAM), non-volatile memory, read only memory (ROM), or flash memory. The memory 106 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 104 may retrieve computer program code instructions that may be stored in the memory 106 for execution of the computer program code instructions. The processor 104 may be embodied in a number of different ways. For example, the processor 104 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 104 may include one or more processing cores configured to perform independently. A multi-core processor may enable multiprocessing within a single physical package. Additionally, or alternatively, the processor 104 may include one or more processors configured in tandem via the bus to enable independent execution of instructions, pipelining, and/or multithreading.

Additionally, or alternatively, the processor 104 may include one or more processors capable of processing large volumes of workloads and operations to provide support for big data analysis. In an example embodiment, the processor 104 may be in communication with a memory 106 via a bus for passing information among components of the system 100.

The memory 106 may be non-transitory and may include, for example, one or more volatile and/or non-volatile memories. In other words, for example, the memory 106 may be an electronic storage device (for example, a computer readable storage medium) comprising gates configured to store data (for example, bits) that may be retrievable by a machine (for example, a computing device like the processor 104). The memory 106 may be configured to store information, data, contents, applications, instructions, or the like, for enabling the apparatus to carry out various functions in accordance with an example embodiment of the present disclosure. For example, the memory 106 may be configured to buffer input data for processing by the processor 104.

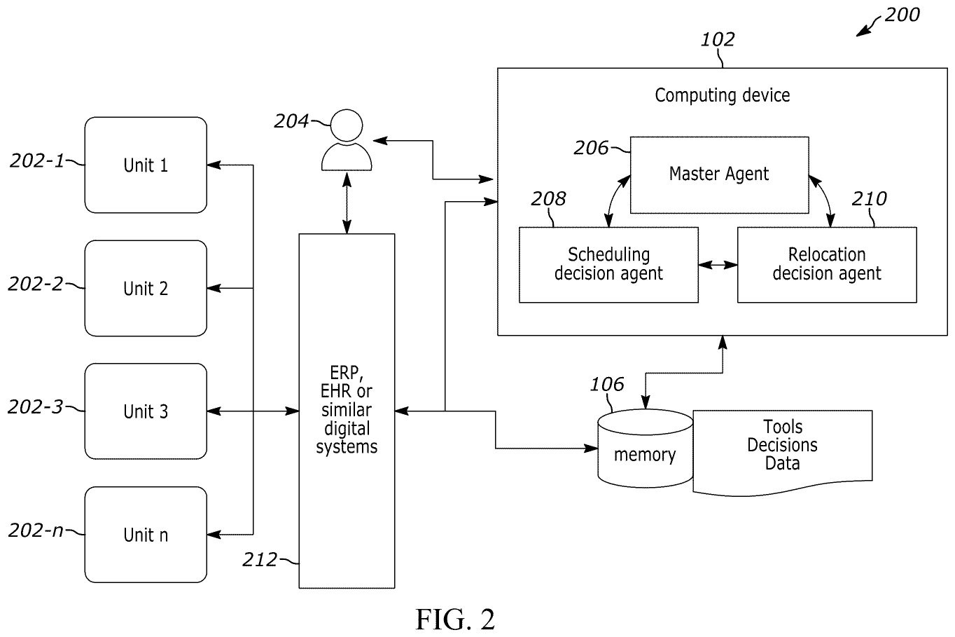

The computing device 102 may be capable of optimizing employee allocation across multiple units. The memory 106 may store instructions that, when executed by the processor 104, cause the computing device 102 to perform one or more operations of the present disclosure which will be described in greater detail in conjunction with FIG. 2. In an embodiment, the computing device 102 may include a master agent, a scheduling decision agent, and a relocation decision agent. The computing device 102 may be configured to receive a plurality of data associated with the plurality of units. The plurality of data include one or more of a demand of the plurality of units, employee details, employee preference, patient data, employee skills, and scheduling constraints. Further, the computing device 102 may be configured to identify an employee pool, a skill demand and a workload index of each of the plurality of units using a skill-workload forecaster tool. The computing device 102 may further generate a schedule for each of the plurality of units based on the skill demand, the workload index, and the scheduling constraints using a scheduling solver tool. Further, the computing device 102 may be configured to identify one or more surplus units and deficit units from each of the plurality of units, and one or more deficit skills based on the generated schedule using a schedule evaluation tool. The computing device 102 may determine that an employee relocation is required based on the one or more surplus units, deficit units and deficit skills. Further, the computing device 102 may be configured to identify the employees that are eligible for the relocation from the surplus units based on the one or more deficient skills and employee preferences. Further, the computing device 102 may validate a plurality of employee relocation options based on the identified eligible employees using a relocation option identifier tool. Further, the computing device 102 may execute an optimal employee relocation option from the plurality of validated employee relocation options using a relocation optimizer tool.

The external devices 108 may refer to various hardware and software tools that may be integrated with the system 100 to enhance its functionality. The complete process followed by the system 100 is explained in detail in conjunction with FIG. 2 to FIG. 6.

FIG. 2 illustrates a block diagram of a system architecture 200 for optimizing employee allocation across multiple units, in accordance with an example embodiment. The system architecture 200 may include a plurality of units (labelled through 202-1 to 202-n), an operator 204, an enterprise system 212 such as an Electronic Health Record/Enterprise Resource Planning (EHR/ERP), the memory 106, and the computing device 102.

In an embodiment, the operator 204 may be a human such as an administrator or charge nurse which interacts with the computing device 102 that exchanges data with the enterprise system 212 such as an ERP/EHR and with the individual units labelled through 202-1 to 202-n. The memory 106 may store configuration, models, intermediate results, and historical decisions, and a tools/decisions/data layer provides callable forecasting and optimization tools used by the computing device 102. The memory 106 may be a persistent store such as a relational database, document store, or object storage that maintains employee/skill matrices, preferences, and eligibility, model artifacts and solver configurations, historical schedules, fitness scores, and relocation decisions for audit and learning, and policy templates and parameter weights. The computing device 102 may include a master agent 206, a scheduling decision agent 208, and a relocation decision agent 210 which may automate requirement gathering, schedule generation or evaluation, and inter-unit 202 employee relocation selection.

Each unit 202 may represents a worksite or service node such as hospital wards, clinics, labs, distribution sites, manufacturing cells, or call-center teams. The unit 202 expose interfaces for publishing demand signals such as appointments, work orders and tickets, receiving schedules and relocation directives, and reporting compliance and outcomes such as attendance, overtime, SLA attainment. In some embodiments, the unit 202 may be physical location such as a ward or logical such as a virtual team operating across locations. Further, the enterprise system 212 maintain authoritative records for workforce, qualifications, availability, leave, payroll, budgeting, patient encounters, and appointments. The computing device 102 reads inputs such as employee rosters, certification matrices, constraints and pushes outputs such as finalized rosters, relocation orders via secure Application Programming Interfaces (APIs) or data buses. In an embodiment, the operator 204 reviews computing device 102 recommendations, resolves conflicts, provides missing inputs, and approves enactment to the enterprise system 212. The operator 204 may set business priorities such as weigh “patient care quality” vs. “overtime minimization” to optimize the employee allocation at each unit 202.

In an embodiment, the master agent 206 may be configured to receive a plurality of data associated with the plurality of units. The plurality of data includes one or more of a demand of the plurality of unit 202, employee details, employee preference, patient data, employee skills, and scheduling constraints. The demand of the plurality of unit 202 may include the number of patients, service requests, or operational load, the employee details may include availability, certifications, and contractual obligations, the employee preferences may include preferred working hours, non-preferred units, or geographic constraints, the patient data may include appointment schedules, treatment categories, and severity or acuity levels, the employee skills include specialized training, qualifications, or roles such as supervisors and critical care staff, and the scheduling constraints may include labour laws, shift durations, break requirements, and budgetary limits. Further, the master agent 206 may be configured to identify an employee pool, a skill demand and a workload index of each of the plurality of units using a skill-workload forecaster tool. The employee pool may represent the set of available employee resources for each unit 202, categorized by the respective skills and availability. The skill demand may be derived as the type and quantity of skills required to meet forecasted operational requirements in a given time window. The workload index may quantify the intensity of expected tasks for each shift, accounting for patient acuity, treatment complexity, and forecasted service volumes.

In some embodiments, the skill-workload forecaster tool includes at least one of a Machine Learning (ML) model and a rule based engine to generate the skill demand and workload index. The ML model may be trained on historical patient data, employee performance records, and shift outcomes to predict future skill requirements and workload intensity. The ML model, trained on historical data, identifies patterns and correlations between patient characteristics, treatment types, and required staffing skills, forecasting skill requirements for each shift. In other embodiments, or in combination, the rule-based engine may apply heuristics and domain-specific rules, such as regulatory staffing ratios, minimum supervisor requirements, or predefined workload scores for certain patient categories, to derive skill demand and workload measures. The combination of ML-based prediction and rule-based reasoning allows the skill-workload forecaster tool to adapt dynamically to real-time operational changes while maintaining compliance with established regulations.

In an embodiment, the scheduling decision agent 208 is configured to generate a schedule for each of the plurality of units based on the skill demand, the workload index, and the scheduling constraints using a scheduling solver tool. The scheduling solver tool may be a computational optimization engine that resolves a multi-objective scheduling problem. The scheduling solver tool formulates the skill demand, the workload index, and the scheduling constraints into an optimization problem where the decision variables represent potential employee-to-shift assignments. The scheduling solver tool then evaluates feasible assignments using one or more optimization techniques. The scheduling solver tool is designed to simultaneously satisfy constraints such as labour laws, shift lengths, mandatory breaks, and employee preferences, while also ensuring adequate skill coverage and balanced workloads across shifts. The scheduling solver tool may include one or more optimization techniques selected from a group consisting of a genetic algorithm, a linear programming algorithm, a constraint programming algorithm, and a reinforcement learning model. In an example, the genetic algorithm may iteratively evolve feasible schedules toward optimality by applying crossover and mutation operations on candidate solutions. The linear programming algorithm may model the scheduling problem as a set of linear equations with decision variables corresponding to employee-shift assignments and constraints enforcing workload limits. The constraint programming may encode the scheduling problem as a set of logical and mathematical constraints, enabling efficient pruning of infeasible solutions. Further, the reinforcement learning model may learn scheduling policies from historical or simulated data, optimizing for long-term metrics such as employee satisfaction and operational efficiency. The flexibility to adopt different optimization paradigms allows the scheduling solver tool to adapt to varying problem sizes, complexity levels, and organizational requirements.

Further, the scheduling decision agent 208 is configured to identify one or more surplus units and deficit units from each of the plurality of units, and one or more deficit skills based on the generated schedule using a schedule evaluation tool. Upon the generation of the schedules, the scheduling decision agent 208 is further configured to invoke a schedule evaluation tool to analyse the generated output schedules. The scheduling decision agent 208 determines whether each unit 202 is surplus (i.e., has more staff or skills than required), deficit (i.e., has insufficient staff or skills), or balanced with respect to predicted workload. In addition, the schedule evaluation tool identifies one or more deficit skills, meaning specific qualifications or certifications that are under-represented in a unit 202 relative to the forecasted demand. The determinations enable the system architecture 200 to precisely locate imbalances across the plurality of unit 202 and skill categories.

In an embodiment, the scheduling decision agent 208 may be configured to compute a schedule fitness score indicative of the surplus units, the deficit units, and the skill deficit across the plurality of unit 202. The schedule fitness score is a quantitative metric that indicates the adequacy of a generated schedule with respect to predicted demand, workload distribution, and skill requirements across the plurality of unit 202. The schedule fitness score provides a single, interpretable measure of overall schedule quality. A higher score may correspond to a schedule that closely aligns with skill demand, evenly distributes workloads, and minimizes surplus or deficit situations. Conversely, a lower score may indicate inefficiencies such as underutilization of staff, insufficient skill coverage, or overloading of certain unit 202. By quantifying surplus and deficit conditions, the schedule fitness score allows proactive identification of units 202 that may require employee relocations, ensuring continuous operational balance.

In an embodiment, the relocation decision agent 210 is configured to determine that an employee relocation is required based on the one or more surplus units, deficit units and deficit skills. The relocation decision agent 210 applies a relocation-requirement test based on one or more criteria, such as skill coverage falling below a minimum threshold for a shift or horizon, projected overtime exceeding a policy limit, workload imbalance above a tolerance, and a composite schedule fitness score dropping below a configurable value. Further, the relocation decision agent 210 is configured to identify the employees that are eligible for the relocation from the surplus units based on the one or more deficient skills and employee preferences. The eligibility may be established by filtering employees against skill alignment with the listed deficit skills (e.g., certifications/competencies mapped to ICU, oncology, infusion, etc.), availability and contractual constraints (duty hours, maximum consecutive shifts, union rules), role restrictions (e.g., keep at least one supervisor per unit per shift), employee preferences (preferred/non-preferred units, commute bounds), and stability guardrails (caps on relocation frequency to avoid churning the same employees). The result is a structured set of candidates annotated with skills, hours available, and relocation capability attributes.

The relocation decision agent 210 is further configured to validate a plurality of employee relocation options based on the identified eligible employees using a relocation option identifier tool. The relocation option identifier tool validate and enumerate feasible inter-unit 202 relocation options. Each relocation option is a mapping from surplus units to deficit units that assigns specific employees (and hours) to cover listed deficit skills. The relocation option identifier tool formulates a constrained optimization that enforces coverage of target deficit skills, non-violation of the source unit's residual coverage, per-employee limits (hours, rest, max relocations), and stability and cost objectives (e.g., minimize travel/administrative cost, minimize employee movement volatility, and maintain unit-level balance). The relocation option identifier tool outputs a ranked set (e.g., top-N) of validated relocation options guaranteed to be feasible with respect to hard constraints.

Further, the relocation decision agent 210 is configured to execute an optimal employee relocation option from the plurality of validated employee relocation options using a relocation optimizer tool. The relocation optimizer tool reuses the scheduling solver tool to evaluate each of the plurality of validated employee relocation options and select the optimal employee relocation option. For each validated option, the relocation optimizer tool temporarily reconfigures the employee pools of the affected units per the proposed relocations and re-runs the unit-level scheduling solver to produce full schedules consistent with labour rules, shift constraints, and workload indices. Each relocation option is scored via the same evaluation metrics used for initial schedules (e.g., skill coverage, overtime, workload balance, preference satisfaction, and the schedule fitness score). Further, reusing the scheduling solver tool ensures model consistency between baseline schedules and relocation-augmented schedules, and avoids divergence between feasibility checks and final allocations. The relocation optimizer tool selects the optimal relocation option according to a configurable objective (e.g., maximize fitness score; tie-break by minimal relocations or minimal overtime). After selection, the relocation decision agent 210 executes the optimal option by updating the assignment artifacts and locking relocation red hours, integrating with the enterprise system 212 systems (e.g., EHR/ERP) to reflect employee locations and roles for the relevant horizon, notifying stakeholders (unit leads, affected employees) and capturing audit logs of the decision rationale and constraints, and scheduling post-execution monitoring.

In some embodiments, the relocation decision agent 210 is configured to determine that the employee relocation is not required based on the one or more surplus units, deficit units and deficit skills. Further, the relocation decision agent 210 is configured to trigger the master agent 206 to continuously receive the plurality of data associated with the plurality of units 202. The relocation decision agent 210 may determine that employee relocation is not required when the generated schedules satisfy one or more no-relocation conditions, including, all units 202 meet or exceed forecasted skill demand with zero (or below-threshold) deficit skills across the planning horizon, any surplus units remain within a tolerance that does not degrade their own coverage or create excessive underutilization, and the schedule fitness score exceeds a configurable acceptance threshold. Upon deciding that employee relocations are unnecessary, the relocation decision agent 210 may trigger the master agent 206 to continuously receive the plurality of data associated with the units 202 so that the system 200 remains situationally aware.

Further, the master agent 206 may interact with at least one of the EHR and the ERP to implement the optimal employee relocation option. The master agent 206 implements the selected optimal employee relocation option by programmatically interfacing with one or both of the EHR system and the ERP system. The master agent 206 translates the relocation optimizer tool's output such as employee identifiers, source/target units, skills, effective dates/times, and hour allocations into system-specific transactions that update unit 202 rosters and shift assignments in the EHR, and effect HR/operations changes such as temporary cost-center, location, or supervisor changes in the ERP.

In an exemplary embodiment, the master agent 206 may orchestrate the end-to-end workflow. The master agent 206 may gather requirements such as demand forecasts, patient/work orders, employee pools, preferences, checks completeness/consistency, dispatches work to the scheduling and relocation agents and manages human-in-the-loop approvals and final execution back to ERP/EHR. The master agent 206 may enforce global policies such as labour law, budget, system-wide fairness and persists decisions to memory. Further, the scheduling decision agent 208 may operate primarily at the unit level. The scheduling decision agent 208 may pull the latest skill demand and workload index per shift from forecasting tools, applies people constraints such as certifications, supervisor coverage, preferences and shift constraints such as lengths, breaks, and holidays, and calls a configurable scheduling solver to produce candidate unit schedules. The scheduling decision agent 208 may then compute schedule fitness metrics and flags surplus/deficit units and skill shortfalls as inputs to relocation analysis. Further, the relocation decision agent 210 may work at the multi-unit level. Based on the unit fitness results, the relocation decision agent 210 determines whether inter-unit relocations are needed, identifies a relocatable-employee pool such as employees who opted-in and match the deficient skills. Further, the relocation decision agent 210 may run a relocation options identifier to generate feasible mapping options and leverages a relocation optimizer tool which may reuse the scheduling solver tool to evaluate options and select one for enactment. The scheduling decision agent 208 aims to balance supply across units, honour preferences, and avoid over-shuttling individuals.

In an embodiment, the master agent 208 pulls rosters, certifications, rules, leave, budgets from ERP/HER, pulls demand and appointments from EHR and ingests operator 202 preferences/weights. Further, the scheduling decision agent 208 may invoke the skill-workload forecaster tool to obtain unit-wise skill demand and workload index (0-1) per shift for the horizon. Further, the scheduling decision agent 208 may configure the solver with people/shift constraints and forecasted demand/workload, runs the solver for each unit, and computes fitness metrics. The scheduling decision agent 208 identifies surplus/deficit units and deficient skills are produced. The identified surplus/deficit units and deficient skills are transmitted to the relocation decision agent 210. The relocation decision agent 210 examines unit fitness and determines whether relocations are required to meet service and fairness thresholds. Further, the relocation decision agent 210 filters employees which are eligible and willing for relocation, then runs the relocation options identifier to generate top-N feasible inter-unit mapping options that maintain stability and balance. The relocation decision agent 210 evaluate each option by re-running the scheduling solver tool with adjusted unit pools to score service quality, overtime, and satisfaction objectives. Further, the best option is selected with optional operator confirmation. Finally, the master agent 206 posts finalized schedules and relocation directives to ERP/EHR for enactment at unit 202, and logs outcomes for feedback.

In some embodiments, the master agent 206, the scheduling decision agent 208, and the relocation decision agent 210 may be cloud-hosted (multi-tenant SaaS), on-premises, hybrid or packaged as microservices in containers or serverless functions. Further, the scheduling solver tool may be a pluggable multi-objective GA, LP/CP-SAT, or GNN-RL. The relocation optimizer tool may reuse the same solver to evaluate mapped pools. Forecasting may be time-series ML plus rule heuristics. Further, fitness and business KPIs such as patient-care %, employee-satisfaction %, total overtime hours may be computed and stored for continuous tuning of solver weights and policies.

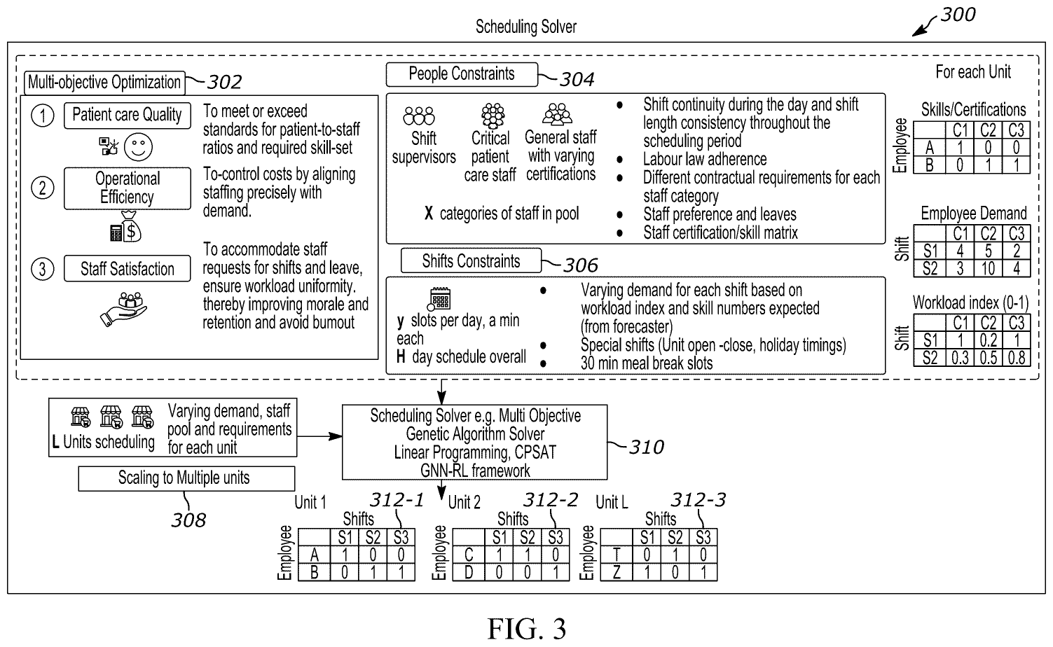

FIG. 3 illustrates a block diagram of a system architecture 300 of the scheduling solver tool 310, in accordance with an example embodiment. The system architecture 300 depicts data paths, and execution order for employee scheduling across one or more organizational units such as wards, stores, teams. FIG. 3 is explained in conjunction with the FIGS. 1 and 2.

In an embodiment, the scheduling solver tool 310 may be configured to receive multiple objectives 302 that provides what to optimize and how to trade off goals. The multiple objectives 302 may include an objective set such as patient/mission quality (coverage of required skills, continuity of care), operational efficiency (cost, overtime, idle time), and staff satisfaction (leave & preference honouring, fairness/workload balance). Further, the multiple objectives 302 may include prioritization schema such as weights or lexicographic priority (e.g., “meet demand first, then minimize cost, then maximize satisfaction”). The multiple objectives 302 may also include Target/thresholds such as minimum acceptable coverage %, max OT, fairness variance caps.

Further, the scheduling solver tool 310 may be configured to receive people constraints 304 that is a structured set of who can do what and under which rules. In some embodiment, the people constraints 304 may include Staff catalogue such as employee IDs, roles, multi-skill/certification matrix, seniority, an Eligibility/qualification rules such as per-skill certification, role minimums (e.g., at least one supervisor per shift), an availability & preferences such as requested shifts/off days, planned leave, Labor/contract rules such as max daily/weekly hours, minimum rest windows, rotation/anti-fatigue policies, and per-unit staff pool which employees belong to (or are shared with) each unit.

In an embodiment, the scheduling solver tool 310 may be configured to receive shifts constraints 306 that may be a formal description of when work happens and how much manpower and what skills are needed. The shifts constraints 306 may include H-day schedule, y slots/day, slot length a minutes, shift templates (start/end), shift-length consistency, Coverage demand such as required headcount per shift×skill (from forecaster), Workload index such as intensity per shift used to balance heavy/light duties, and operational rules such as mandated 30-min meal breaks, open/close/holiday shifts, special events.

In some embodiments, the scheduling solver tool 310 may be configured to receive scaling to multiple units 308 that parcels inputs by unit and runs the scheduling solver tool 310 efficiently. The scaling to multiple units 308 may include parallelization policy such as run units independently (default) or with coupling hooks (optional) for enterprise balancing. Further, the scaling to multiple units 308 may include common services such as data validation, default fill-ins, time-limit/gap settings for solver runs, and collection of outputs.

Further, the scheduling solver tool 310 may be configured to produce an optimized schedule for employee allocation multiple units. The scheduling solver tool 310 may normalize the inputs into arrays/matrices such as eligibility Q, availability A, demand D, workload W. The scheduling solver tool 310 treats skills as first-class requirements so multi-skilled staff may satisfy different skill demands within legal limits. For each unit, the scheduling solver tool 310 may returns a schedule matrix (Employee×Shift with skill/role), i.e., 312-1/312-2/312-3, collectively referred as 312. The scheduled matrix 312 may serve as the initial schedules used by the downstream evaluation/relocation stage.

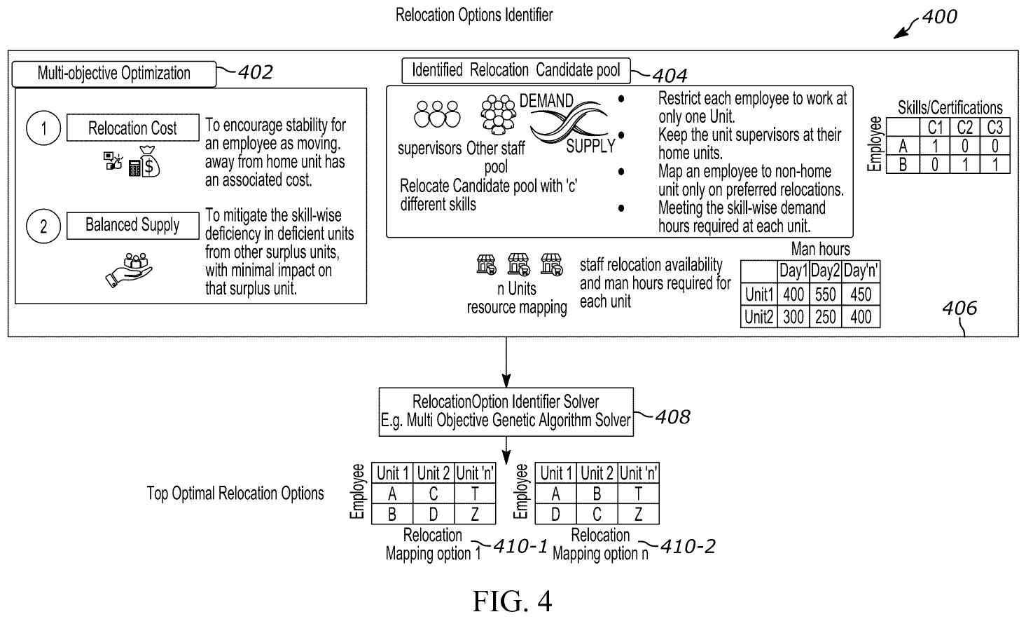

FIG. 4 illustrates a block diagram of a system architecture 400 of the relocation option identifier tool 408, in accordance with an example embodiment. The relocation option identifier tool 408 may be configured to rebalance staff between units by proposing temporary relocations that relieve deficits while controlling business cost and disruption. FIG. 4 is explained in conjunction with the FIGS. 1, 2 and 3.

In an embodiment, the relocation option identifier tool 408 initializes a multi-objective policy 402 with weights or a lexicographic order for relocation cost such as encourage home-unit stability and minimize disruption, and balanced supply such as reduce skill-wise deficits in needy units without creating new deficits in donors. Further, the relocation option identifier tool 408 receives a candidate pool 404 of employees eligible for temporary re-assignment (multi-skill profiles), plus hard business rules such as one unit per employee in a period, keep supervisors at home unless explicitly whitelisted, respect “preferred relocation” lists, and meet skill/shift demand at the receiving unit. Qualification matrices and preference flags gate feasibility.

In an embodiment, the relocation option identifier tool 408 reads per-unit demand/supply ledgers (e.g., daily man-hours required per skill versus available, staff availability for relocation windows, holiday/open/close constraints), defining where surplus exists and where deficits must be filled. Using the inputs above, the relocation option identifier tool 408 may constructs and solves a combinatorial assignment such as pick a set of (employee, from-unit to unit, day/shift, skill, hours) relocations that obey all gating rules from the candidate pool 404 and optimize the objectives from the multi-objective policy 402 under the unit-level ledgers in the resource mapping 406. Finally, the relocation option identifier tool 408 may return a ranked list of relocation mapping options (e.g., 410-1 . . . 410-n), each option detailing who moves, to which unit, for which skill/shift, and for how many hours, with objective scores and feasibility checks.

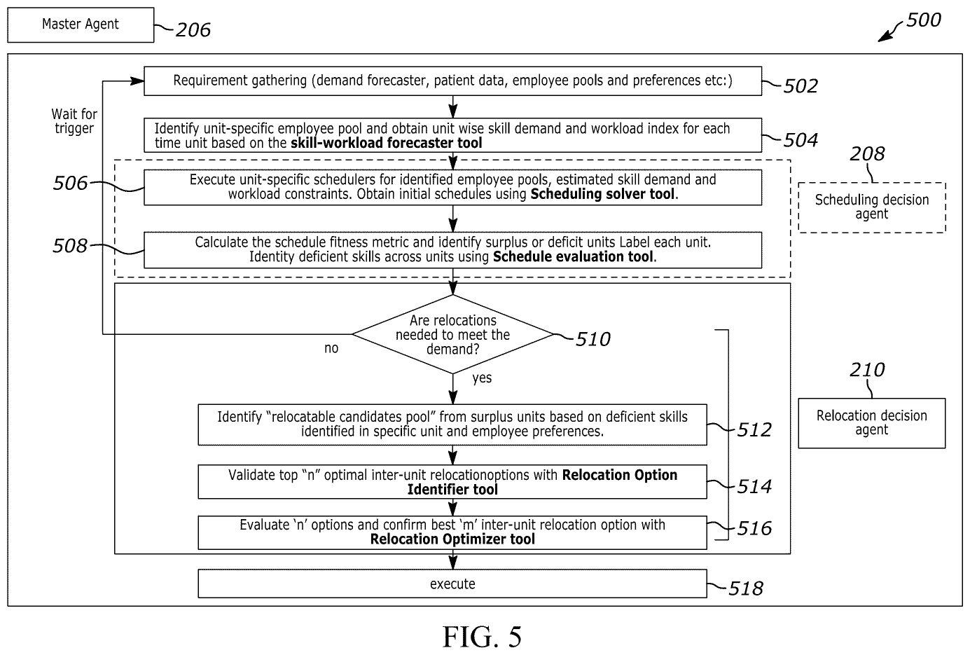

FIG. 5 illustrates a flow diagram of a method 500 for optimizing employee allocation across multiple units, in accordance with an example embodiment. The method 500 may be implemented by the master agent 206, the scheduling decision agent 208, and the relocation decision agent 210 of the computing device 102. FIG. 5 is explained in conjunction with the FIGS. 1, 2, 3 and 4.

At step 502, the master agent 206 aggregates inputs such as demand/forecast drivers (e.g., patient appointments and categories), current employee pools and skills/certifications, employee preferences and availability, and applicable scheduling constraints (labour rules, shift lengths, breaks, supervisor coverage, budgets) needed to start scheduling.

At step 504, for each unit and time bucket such as shift, the master agent 206 fixes the unit's baseline employee pool and invokes a skill-workload forecaster tool to produce a skill-demand profile (counts by required certification/skill), and a normalized workload index (e.g., 0-1) reflecting intensity from patient acuity and treatment type. The skill-workload forecaster tool may combine ML with rule-based heuristics.

At step 506, Each unit is optimized independently using a scheduling solver tool 310 that respects people constraints such as skills, supervisors, contracts, shift constraints such as durations, breaks, special shifts, workload indices, and forecasted skill demand. The scheduling solver tool 310 may use GA, LP/CPSAT, CP, or RL to jointly optimize patient-care quality, operational efficiency (e.g., overtime), and employee satisfaction, yielding unit-level schedule.

At step 508, the scheduling decision agent 208 analyse the generated schedules to compute a schedule fitness score and to label each unit as surplus or deficit while pinpointing deficit skills. The fitness score aggregates factors like coverage vs. demand, workload balance, overtime, and preference adherence.

At step 510, the relocation decision agent 210 may determine whether employee relocation is required based on the surplus units, deficit units, and skill deficiency. If the employee relocation is required, the master agent 206 may hold and monitor for time- or event-based triggers such as next planning cycle, new admissions, cancellations, sick calls.

At step 512, from surplus units, the relocation decision agent 210 filters an eligible employee pool. The eligible employee pool include the employees whose skills match listed deficits, who are available under labour/contract rules, who satisfy role policies (e.g., keep at least one supervisor at source), and whose stated unit preferences allow movement, producing a structured employee set annotated with skills and hours.

At step 514, the relocation decision agent 210 enumerates feasible inter-unit mappings from the eligible pool, enforcing hard constraints (coverage at source and destination, per-employee limits, stability caps) while optimizing soft goals (reduced relocation cost/volatility, balanced supply) using the Relocation Option Identifier tool 408. The Relocation Option Identifier tool 408 returns ranked top-N options for deeper evaluation.

At step 516, each relocation option is re-simulated by reconfiguring unit pools per the proposed relocations and re-running the same scheduling solver tool 310. The relocation options are scored on fitness, coverage, overtime, and stability. The best relocation option is selected as the optimal employee relocation option.

At step 518, the master agent 210 commits the chosen relocation option including updating rosters and assignments and, integrating with EHR/ERP to reflect location/role, cost-center, and schedule changes, with notifications and audit logs.

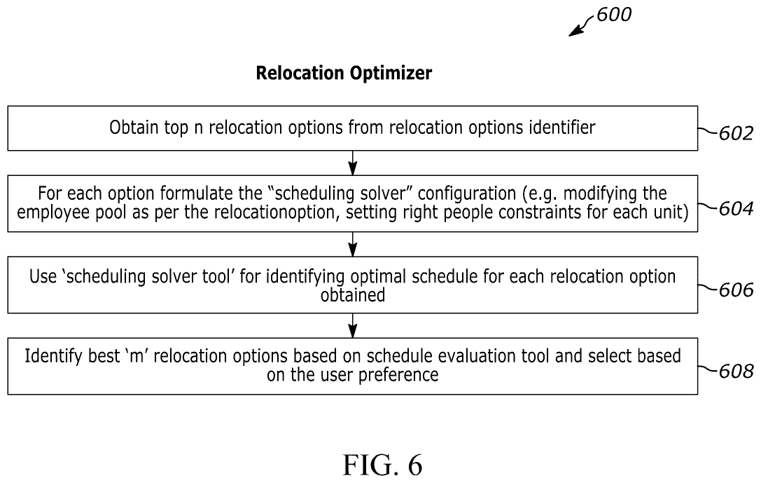

FIG. 6 illustrates a flow diagram of a method 600 for relocation optimization of employee allocation across multiple units, in accordance with an example embodiment. The method 600 may be implemented by the relocation optimizer tool of the relocation decision agent 210. FIG. 6 is explained in conjunction with the FIGS. 1, 2, 3, 4 and 5.

At step 602, the relocation optimizer tool ingests a ranked list of validated inter-unit employee relocation options produced by the relocation option identifier tool 408. Each relocation option specifies concrete employee reallocations such as employee IDs, source unit, destination unit, effective window, intended skill role, hours that satisfy hard constraints such as minimum supervisor coverage at source, certification matches at destination, per-employee duty/hour limits and optimize soft goals such as stability and relocation cost. The list is bounded to N options to cap combinatorial growth while preserving high-quality employee relocation options.

At step 604, For each employee relocation option, the relocation optimizer tool reconfigures unit contexts so the downstream scheduler can evaluate the option under full operational constraints.

At step 606, the relocation optimizer tool reuses the scheduling solver tool 310 that generated the baseline unit schedules as explained in detail in FIG. 5 to recompute end-to-end schedules under each employee relocation options. Any of several optimization techniques may be employed such as genetic algorithms, linear/constraint programming, or reinforcement learning without changing the problem's inputs/outputs.

At step 608, the relocation optimizer tool computes a schedule fitness score for the schedules produced under each option and ranks the options. The relocation options failing acceptance thresholds such as any critical-skill shortfall, overtime above policy, or fitness below a minimum are discarded. From the remainder, the best m are retained, and ties are broken by secondary criteria such as fewer people moved, lower relocation volatility/cost, or higher preference satisfaction.

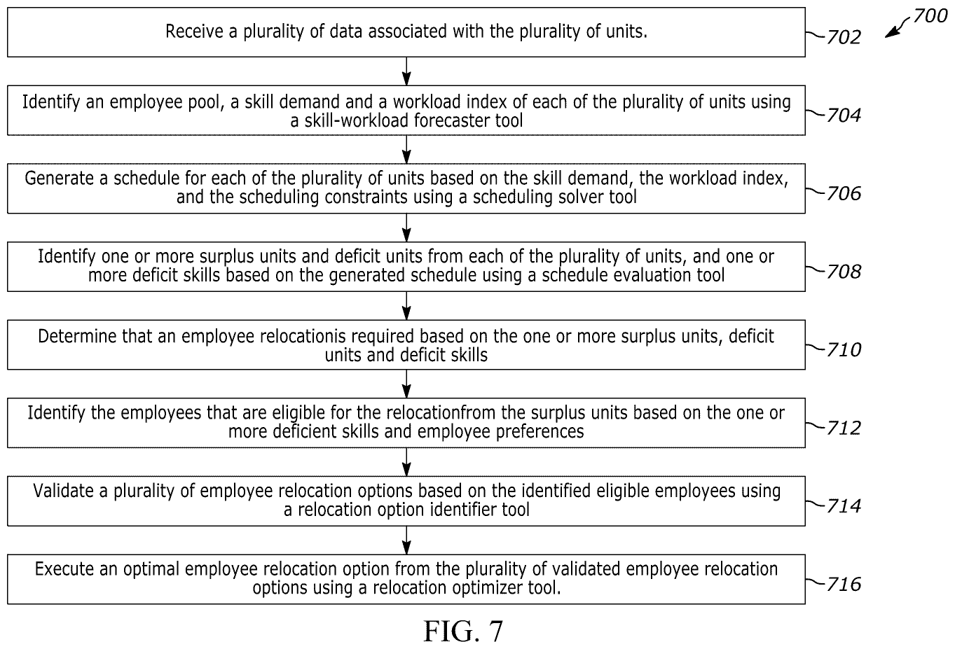

FIG. 7 illustrates a flow diagram of a method 700 for optimizing employee allocation across multiple units, in accordance with an example embodiment. FIG. 7 is explained in conjunction with the FIGS. 1, 2, 3, 4, 5 and 6. It will be understood that each block of the flow diagram of the method 700 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 106 of the computing device 102, employing an embodiment of the present disclosure and executed by a processor 104. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At step 702, the method 700 may include receiving a plurality of data associated with the plurality of units. The plurality of data includes one or more of a demand of the plurality of units, employee details, employee preference, patient data, employee skills, and scheduling constraints.

The method 700, at step 704, may include identifying an employee pool, a skill demand and a workload index of each of the plurality of units using a skill-workload forecaster tool. The skill-workload forecaster tool includes at least one of a Machine Learning (ML) model and a rule based engine to generate the skill demand and workload index.

At step 706, the method 700 may include generating a schedule for each of the plurality of units based on the skill demand, the workload index, and the scheduling constraints using a scheduling solver tool 310. The scheduling solver tool 310 includes one or more optimization techniques selected from a group consisting of a genetic algorithm, a linear programming algorithm, a constraint programming algorithm, and a reinforcement learning model.

At step 708, the method 700 may include identifying one or more surplus units and deficit units from each of the plurality of units, and one or more deficit skills based on the generated schedule using a schedule evaluation tool. The method 700 further includes computing a schedule fitness score indicative of the surplus units, the deficit units, and the skill deficit across the plurality of units.

The method 700, at step 710, may include determining that an employee relocation is required based on the one or more surplus units, deficit units and deficit skills. In simpler words, if deficits/skill shortfalls persist, or fitness score, overtime, or imbalance cross thresholds, the relocation decision agent determines that inter-unit employee relocations are required to satisfy demand while maintaining policy and service objectives.

In an embodiment, the method 700 may include determining that the employee relocation is not required based on the one or more surplus units, deficit units and deficit skills. Further, the method 500 may include continuously receiving the plurality of data associated with the plurality of units. In simpler words, if all acceptance criteria are met such as adequate coverage, balanced workload, acceptable overtime, high fitness score, no relocation is initiated. The relocation decision agent continues to receive live data and retriggers forecasting/scheduling when time- or event-based changes occur.

At step 712, the method 700 may include identifying the employees that are eligible for the relocation from the surplus units based on the one or more deficient skills and employee preferences. In simpler words, from surplus units, employees eligible to move are filtered by skill match to listed deficits, availability and contractual limits, role safeguards, and stated unit/location preferences, yielding a structured employee pool.

At step 714, the method 700 may include validating a plurality of employee relocation options based on the identified eligible employees using a relocation option identifier tool. In simpler words, the relocation option identifier tool constructs and validates multiple feasible inter-unit mappings from the employee pool, enforcing all hard constraints at source/destination and stability limits, and returns a ranked set of top-N options for scoring.

At step 716, the method 700 may include executing an optimal employee relocation option from the plurality of validated employee relocation options using a relocation optimizer tool. The relocation optimizer tool reuses the scheduling solver tool to evaluate each of the plurality of validated employee relocation options and select the optimal employee relocation option. In simpler words, each validated option is re-evaluated by reusing the scheduling solver tool to build full schedules under that relocation option. Further, the relocation options are scored based on fitness score, coverage, overtime, stability, the optimal relocation option is selected.

In an embodiment, the method 700 may include implementing the optimal employee relocation option using at least one of an Electronic Health Record (EHR) and an Enterprise Resource Planning (ERP). In simpler words, the chosen relocation option is implemented by updating clinical rosters and assignments in the EHR and applying HR/operations changes in the ERP such as temporary location/cost center.

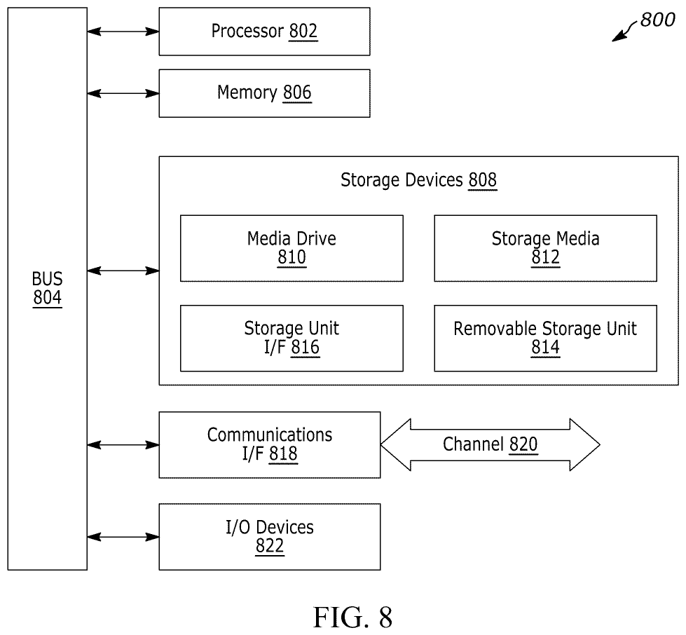

The disclosed methods and systems may be executed on a conventional or general-purpose computing system, such as a personal computer (PC) or server. Referring to FIG. 8, an exemplary computing system 800 is illustrated, which may implement processing functionality for various embodiments (e.g., as a SIMD device, client device, server device, or one or more processors). Those skilled in the art will recognize that other computing systems or architectures may also be used to implement the invention. The computing system 800 may represent a user device, such as a desktop, laptop, mobile phone, personal entertainment device, DVR, or any other special or general-purpose computing device appropriate for a given application or environment. The computing system 800 may include one or more processors, such as processor 802, implemented using a general-purpose or specialized processing engine, such as a microprocessor, microcontroller, or other control logic. In some embodiments, processor 802 may be an AI processor, implemented as a Tensor Processing Unit (TPU), graphical processing unit (GPU), or custom-programmable solution, such as a Field-Programmable Gate Array (FPGA).

The computing system 800 may further include memory 806 (e.g., Random Access Memory (RAM) or other dynamic memory) for storing instructions and information to be executed by processor 802. Memory 806 may also store temporary variables or intermediate information during execution. Additionally, the computing system 800 may include a read-only memory (ROM) or other static storage device connected to bus 804 for storing static information and instructions for processor 802.

Storage devices 808 may also be included in computing system 800, consisting of, for example, a media drive 810 and a removable storage interface. Media drive 810 may support fixed or removable storage media, such as hard disk drives, floppy drives, magnetic tape drives, SD card ports, USB ports, optical disk drives (e.g., CD or DVD drives), or other media. Storage media 812 may include hard disks, magnetic tapes, flash drives, or other media that can be read and written to by media drive 810. Storage media 812 may store computer-readable software or data.

Alternatively, storage devices 808 may include other means for loading computer programs or data into computing system 800, such as removable storage unit 814 and interface 816, program cartridges, removable memory (e.g., flash memory), memory slots, and similar storage units and interfaces.

Computing system 800 may also include a communications interface 818 to relocation software and data between external devices 112 and system 100. Examples include network interfaces (e.g., Ethernet), communication ports (e.g., USB, micro-USB), Near Field Communication (NFC), and other protocols. The signals transmitted via communications interface 818 may include electronic, electromagnetic, optical, or other forms of transmission through channel 820, which may utilize wireless mediums, fibre optics, wires, or cables.

Computing system 800 may also include Input/Output (I/O) devices 822, such as a display, keypad, microphone, speakers, vibration motors, LED indicators, etc., allowing user interaction and feedback. The term “computer-readable medium” may refer to any storage medium used, such as memory 806, storage devices 808, removable storage unit 814, or signal(s) on channel 820. Such media may store sequences of instructions, or “computer program code,” which, when executed, enable computing system 800 to perform the methods and functions described in embodiments of the invention.

In embodiments where elements are implemented in software, the software may be stored on a computer-readable medium and loaded into computing system 800 via removable storage unit 814, media drive 810, or communications interface 818. When executed by processor 802, this control logic (e.g., software instructions or computer program code) causes processor 802 to perform the invention's functions as described.

As will be appreciated by those skilled in the art, the techniques described in the various embodiments discussed above are not routine, or conventional, or well understood in the art. The techniques discussed above provide for innovative solutions to address the challenges associated with explainable optimization of employee allocation across multiple units. The disclosed techniques offer several advantages over the existing methods:

Skill-Specific Scheduling: The present disclosure enables scheduling based on employee certifications and skill sets rather than raw headcount, ensuring that each shift has the required expertise (e.g., oncology, infusion, ICU) rather than just a fixed number of employees.

Workload-Aware Assignment: The present disclosure incorporates a workload index derived from patient acuity, treatment type, and intensity, preventing employee burnout by balancing heavy-load and light-load shifts across employees.

Multi-Unit Relocation Optimization: The present disclosure introduces an automated mechanism for inter-unit staff relocations, accounting for both skill requirements and employee preferences, avoiding ad hoc manual relocations, reduces overtime costs, and ensures equitable workload distribution across units.

Agentic Workflow for Orchestration: The present disclosure leverages multiple AI agents (master agent, scheduling decision agent, relocation decision agent) to orchestrate data gathering, forecasting, scheduling, and relocation optimization. The agentic design ensures modularity, reusability of optimization tools, and minimal manual intervention.

Forecast-driven demand prediction: A skill-workload forecaster integrates machine learning models with heuristic rules to predict skill demand and workload intensity for future shifts, enhancing scheduling accuracy and adaptability to fluctuating patient loads.

Integration with enterprise systems: The present disclosure interact with Electronic Health Records (EHR) and Enterprise Resource Planning (ERP) systems to implement schedules and relocations seamlessly, ensuring compatibility with real-world hospital operations.

The disclosed techniques offer several applications including:

Healthcare Workforce Management: The present disclosure may be applied in hospitals and nursing homes to schedule doctors and nurses across multiple units, ensuring skill-specific coverage, balanced workloads, and efficient staff relocations to handle patient surges and critical care requirements.

Call centers and customer support: The present disclosure optimizes agent allocation based on language skills, certifications, and workload intensity, while enabling smooth inter-team relocations to manage sudden spikes in customer queries or service demands.

Manufacturing plants: The present disclosure schedule technicians and operators across different production lines, considering machine-specific skills, workload variations, and compliance requirements, while dynamically relocating skilled employees between units to prevent bottlenecks and maintain production efficiency.

Airlines and airports: The present disclosure may be used to allocate pilots, crew members, and ground staff based on certifications, duty regulations, and workload intensity, while enabling inter-terminal or inter-flight staff relocations to ensure safety, compliance, and operational smoothness.

Retail and logistics: Retail chains and warehouses may use the system for workforce planning, assigning employees based on workload forecasts (festive sales, seasonal demand), and enabling relocations between stores or hubs to avoid understaffing and enhance customer service.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A system for optimizing employee allocation across a plurality of units, the system comprising:
a master agent configured to:
receive a plurality of data associated with the plurality of units, wherein the plurality of data comprises one or more of a demand of the plurality of units, employee details, employee preference, patient data, employee skills, and scheduling constraints;
identify an employee pool, a skill demand and a workload index of each of the plurality of units using a skill-workload forecaster tool;
a scheduling decision agent configured to:
generate a schedule for each of the plurality of units based on the skill demand, the workload index, and the scheduling constraints using a scheduling solver tool;
identify one or more surplus units and deficit units from each of the plurality of units, and one or more deficit skills based on the generated schedule using a schedule evaluation tool; and
a relocation decision agent configured to:
determine that an employee relocation is required based on the one or more surplus units, deficit units and deficit skills;
identify the employees that are eligible for the relocation from the surplus units based on the one or more deficient skills and employee preferences;
validate a plurality of employee relocation options based on the identified eligible employees using a relocation option identifier tool; and
execute an optimal employee relocation option from the plurality of validated employee relocation options using a relocation optimizer tool.

2. The computer-implemented system of claim 1, wherein the skill-workload forecaster tool comprises at least one of a Machine Learning (ML) model and a rule based engine to generate the skill demand and workload index.

3. The computer-implemented system of claim 1, wherein the scheduling solver tool comprises one or more optimization techniques selected from a group consisting of a genetic algorithm, a linear programming algorithm, a constraint programming algorithm, and a reinforcement learning model.

4. The computer-implemented system of claim 1, wherein the scheduling decision agent is configured to:
compute a schedule fitness score indicative of the surplus units, the deficit units, and the skill deficit across the plurality of units.

5. The computer-implemented system of claim 1, wherein the relocation decision agent is further configured to:
determine that the employee relocation is not required based on the one or more surplus units, deficit units and deficit skills; and
trigger the master agent to continuously receive the plurality of data associated with the plurality of units.

6. The computer-implemented system of claim 1, wherein the relocation optimizer tool reuses the scheduling solver tool to evaluate each of the plurality of validated employee relocation options and select the optimal employee relocation option.

7. The computer-implemented system of claim 1, wherein the master agent interacts with at least one of an Electronic Health Record (EHR) and an Enterprise Resource Planning (ERP) to implement the optimal employee relocation option.

8. A computer-implemented method for optimizing workforce allocation across a plurality of units, the method comprising:
receiving a plurality of data associated with the plurality of units, wherein the plurality of data comprises one or more of a demand of the plurality of units, employee details, employee preference, patient data, employee skills, and scheduling constraints;
identifying an employee pool, a skill demand and a workload index of each of the plurality of units using a skill-workload forecaster tool;
generating a schedule for each of the plurality of units based on the skill demand, the workload index, and the scheduling constraints using a scheduling solver tool;
identifying one or more surplus units and deficit units from each of the plurality of units, and one or more deficit skills based on the generated schedule using a schedule evaluation tool;
determining that an employee relocation is required based on the one or more surplus units, deficit units and deficit skills;
identifying the employees that are eligible for the relocation from the surplus units based on the one or more deficient skills and employee preferences;
validating a plurality of employee relocation options based on the identified eligible employees using a relocation option identifier tool; and
executing an optimal employee relocation option from the plurality of validated employee relocation options using a relocation optimizer tool.

9. The computer-implemented method of claim 8, wherein the skill-workload forecaster tool comprises at least one of a Machine Learning (ML) model and a rule based engine to generate the skill demand and workload index.

10. The computer-implemented method of claim 8, wherein the scheduling solver tool comprises one or more optimization techniques selected from a group consisting of a genetic algorithm, a linear programming algorithm, a constraint programming algorithm, and a reinforcement learning model.

11. The computer-implemented method of claim 8, further comprising:
computing a schedule fitness score indicative of the surplus units, the deficit units, and the skill deficit across the plurality of units.

12. The computer-implemented method of claim 8, further comprising:
determining that the employee relocation is not required based on the one or more surplus units, deficit units and deficit skills; and
continuously receiving the plurality of data associated with the plurality of units.

13. The computer-implemented method of claim 8, wherein the relocation optimizer tool reuses the scheduling solver tool to evaluate each of the plurality of validated employee relocation options and select the optimal employee relocation option.

14. The computer-implemented method of claim 8, wherein further comprising:
implementing the optimal employee relocation option using at least one of an Electronic Health Record (EHR) and an Enterprise Resource Planning (ERP).

15. A non-transitory computer-readable storage medium having stored thereon computer executable instruction which when executed by one or more processors, cause the one or more processors to carry out operations for optimizing employee allocation across a plurality of units, the operations comprising:
receiving a plurality of data associated with the plurality of units, wherein the plurality of data comprises one or more of a demand of the plurality of units, employee details, employee preference, patient data, employee skills, and scheduling constraints;
identifying an employee pool, a skill demand and a workload index of each of the plurality of units using a skill-workload forecaster tool;
generating a schedule for each of the plurality of units based on the skill demand, the workload index, and the scheduling constraints using a scheduling solver tool;
identifying one or more surplus units and deficit units from each of the plurality of units, and one or more deficit skills based on the generated schedule using a schedule evaluation tool;
determining that an employee relocation is required based on the one or more surplus units, deficit units and deficit skills;
identifying the employees that are eligible for the relocation from the surplus units based on the one or more deficient skills and employee preferences;
validating a plurality of employee relocation options based on the identified eligible employees using a relocation option identifier tool; and
executing an optimal employee relocation option from the plurality of validated employee relocation options using a relocation optimizer tool.
